(19) United States
(12) Patent Application Publication
(10) Pub. No.: US 2024/0106086 A1
(43) Pub. Date: Mar. 28, 2024

(54) ELECTRICALLY CONDUCTIVE STRUCTURE OF LITHIUM BATTERY AND FORMING METHOD THEREOF

(71) Applicant: DIJIYA ENERGY SAVING TECHNOLOGY INC., New Taipei City (TW)

(72) Inventor: Wen-Hung HUANG, New Taipei City (TW)

(21) Appl. No.: 17/955,338

(22) Filed: Sep. 28, 2022

(51) Int. Cl. H01M 50/536; H01M 10/052

(52) U.S. Cl. CPC H01M 50/536; H01M 10/052

(57) ABSTRACT

An electrically conductive structure of lithium battery mainly comprises a housing, a lithium-battery-core, a cover plate, a first-metal-plate and a second-metal-plate. Its forming method is to firstly welding the first-metal-plate to a positive-electrode-tab-set such that the first-metal-plate is completely flat welded to the positive-electrode-tab-set; welding the second-metal-plate to a negative-electrode-tab-set such that the second-metal-plate is completely flat welded to the negative-electrode-tab-set; positioning the cover plate on a workbench such that a first flat mesa and a second flat mesa are both facing upward; overlapping the positive-electrode-tab-set and the negative-electrode-tab-set on the first flat mesa and the second flat mesa respectively and welding from a first-top-surface of the first-metal-plate and a second-top-surface of the second-metal-plate respectively; after welded, putting the lithium-battery-core into the inside of the housing and then welding the cover plate to a top end of the housing.

### FIELD OF THE INVENTION

The present invention is related to an electrically conductive structure of lithium battery and forming method thereof, especially one that the internal resistance of the battery cell can be effectively reduced to make the conduction smooth.

### BACKGROUND OF THE INVENTION

The lithium battery cell currently used mainly comprises a housing with electrolyte solution and lithium battery core inside the housing, wherein the lithium battery core is formed by stacking positive electrodes, isolation films and negative electrodes or further by rolling the stack into roll. When assembling the lithium battery cell, the positive electrode sheet is first welded to the positive electrode tabs, and then the positive electrode tabs are welded to the inner wall of the housing so that the housing and the positive electrode terminal are electrically connected. The negative electrode sheet is welded to the negative electrode tabs, and the negative electrode tabs are welded upward to the bottom of the negative electrode terminal of the housing. In this way, different wire terminals can be fixed respectively to the positive electrode terminal and the negative electrode terminal through screwing screw nuts to the external screw threads on the tops of the positive electrode terminal and the negative electrode terminal, respectively. However, the above-mentioned negative electrode tabs are additionally leaded out from the negative electrode sheet, and then welded to the bottom of the negative electrode terminal. The processing procedure is complicated. The positive electrode tabs are welded to the inner wall of the housing and the negative electrode tabs are welded to the negative electrode terminal. The quality of their solder joints not easy to be controlled, and they often have point-like contacts. Hence, it usually causes problems of poor conduction and heat dissipation. It is only suitable for energy storage with small current, but not suitable for charging and discharging with high rate and large current.

In order to solve the above problems, most of the lithium battery cores currently produced will reserve a plurality of electrode tabs, and then weld the plurality of electrode tabs to the conductive connecting piece by using ultrasonic welding, and then weld the conductive connecting piece to an electrode mesa with the positive electrode terminal and the negative electrode terminal by using laser welding, so as to achieve the effect of conducting electricity, and can meet the needs of high-rate and high-current charging and discharging. However, when the above structure is used in the actual test, since the plurality of core tabs and the conductive connecting pieces are welded and jointed by ultrasonic welding and the conductive connecting pieces are welded on the electrode mesa, welding of so many parts not only the resistance of the battery core will be increased resulting in generating heat and reducing the conductivity, but also the conductive voltage will be unstable resulting in affecting the function and consistency of the lithium battery core and even shortening the life time of the lithium battery.

### SUMMARY OF THE INVENTION

In view of the above, in order to provide a structure that is different from the conventional technology and improve the above shortcomings, the inventors have accumulated many years of experience and continuous research and development improvement, so that the present invention has been invented.

One purpose of the present invention is to provide an electrically conductive structure of lithium battery and forming method thereof to solve the problems caused by the conventional multi parts welding, such as the increased resistance of the battery cell resulting in generating heat and reducing the conductivity, unstable conductive voltage resulting in affecting the function and consistency of the lithium battery core and even shortening the life time of the lithium battery. Through the structure and the method that to weld a positive electrode tab set of the lithium battery core and a first metal plate to a first flat mesa of a bottom end of a positive electrode terminal and weld a negative electrode tab set of the lithium battery core and a second metal plate to a second flat mesa of a bottom end of a negative electrode terminal, the internal resistance can be reduced to smooth the conduction, the conduction voltage can be stabilized to ensure the function and consistency of the lithium battery core, and the life time of the lithium battery can be extended.

In order to achieve the above purpose of the invention, the present invention provides an electrically conductive structure of lithium battery which comprises a housing, a cover plate, a first metal plate and a second metal plate. The housing has a lithium battery core inside. A top end of the lithium battery core has a positive electrode tab set and a negative electrode tab set. A top end of the housing is covered by and welded to the cover plate. The cover plate has a positive electrode terminal and a negative electrode terminal. A bottom end of the positive electrode terminal has a first flat mesa. The first flat mesa is welded to the positive electrode tab set. A bottom end of the negative electrode terminal has a second flat mesa. The second flat mesa is welded to the negative electrode tab set. The first metal plate has a first top surface and a first bottom surface in opposite directions. The first bottom surface is completely flat welded to the positive electrode tab set. The second metal plate has a second top surface and a second bottom surface in opposite directions. The second bottom surface is completely flat welded to the negative electrode tab set.

In implementation, the lithium battery core comprises a first lithium battery core and a second lithium battery core in parallel.

In implementation, the first metal plate is an aluminum plate; the second metal plate is a copper plate.

The forming method of the electrically conductive structure of lithium battery of the present invention comprises following steps of: A: providing the lithium battery core; B: welding the first metal plate to the positive electrode tab set such that the first bottom surface of the first metal plate and the positive electrode tab set are jointed; welding the second metal plate to the negative electrode tab set such that the second bottom surface of the second metal plate and the negative electrode tab set are jointed; C: positioning the cover plate on a workbench such that the first flat mesa and the second flat mesa are both facing upward; D: overlapping the positive electrode tab set on the first flat mesa and welding them from the first top surface of the first metal plate; overlapping the negative electrode tab set on the second flat mesa and welding them from the second top surface of the second metal plate; and E: putting the lithium battery core into the inside of the housing and then welding the cover plate to the top end of the housing.

In implementation, before the step A, the forming method of the present invention further comprises a cutting step: cutting one end of the positive electrode tab set and one end of the negative electrode tab set.

In implementation, in the step B, the first metal plate and the second metal plate are welded to the positive electrode tab set and the negative electrode tab set by ultrasonic welding respectively.

In implementation, in the step D, the welding is by laser welding respectively.

In implementation, the lithium battery core comprises a first lithium battery core and a second lithium battery core. The positive electrode tab set comprises a first positive electrode tab set and a second positive electrode tab set. The negative electrode tab set comprises a first negative electrode tab set and a second negative electrode tab set. The first lithium battery core has the first positive electrode tab set and the first negative electrode tab set. The second lithium battery core has the second positive electrode tab set and the second negative electrode tab set. In the step D, firstly the first lithium battery core and the second lithium battery core are placed in reverse such that the first positive electrode tab set and the second positive electrode tab set are in parallel placed on and welded to the first flat mesa, the first negative electrode tab set and the second negative electrode tab set are in parallel placed on and welded to the second flat mesa; and after welded, the first lithium battery core and the second lithium battery core are bended respectively to be combined.

For further understanding the characteristics and effects of the present invention, some preferred embodiments referred to drawings are in detail described as follows.

### BRIEF DESCRIPTION OF DRAWINGS

FIG. 1 is a components exploded view of an electrically conductive structure of lithium battery of the present invention.

FIG. 2 is a components exploded view of the lithium battery core of the present invention before welded to the first and second metal plates.

FIG. 3 is a schematic perspective view of the present invention that the first and the second metal plates and the positive and the negative electrode tab sets are welded on the first and the second flat mesas respectively.

FIG. 4 is a schematic perspective view of the present invention when welding the first and the second lithium battery cores at the same time.

### DETAILED DESCRIPTIONS OF PREFERRED EMBODIMENTS

An electrically conductive structure of lithium battery of the present invention mainly comprises a housing, a cover plate, a first metal plate and a second metal plate. The housing has a lithium battery core inside. A top end of the lithium battery core has a positive electrode tab set and a negative electrode tab set. A top end of the housing is covered by and welded to the cover plate. The cover plate has a positive electrode terminal and a negative electrode terminal. A bottom end of the positive electrode terminal has a first flat mesa. The first flat mesa is welded to the positive electrode tab set. A bottom end of the negative electrode terminal has a second flat mesa. The second flat mesa is welded to the negative electrode tab set. The first metal plate has a first top surface and a first bottom surface in opposite directions. The first bottom surface is completely flat welded to the positive electrode tab set. The second metal plate has a second top surface and a second bottom surface in opposite directions. The second bottom surface is completely flat welded to the negative electrode tab set.

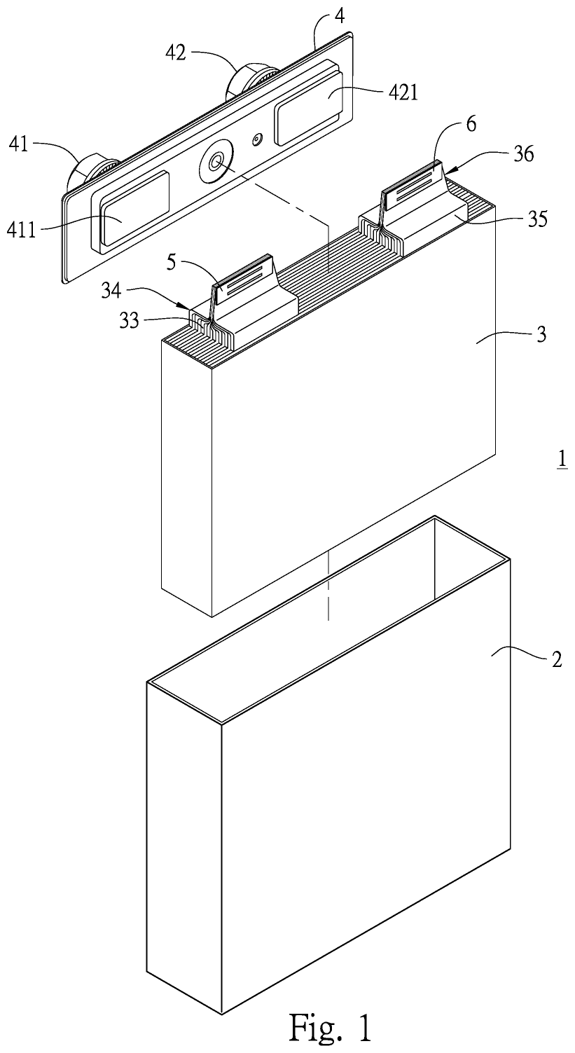

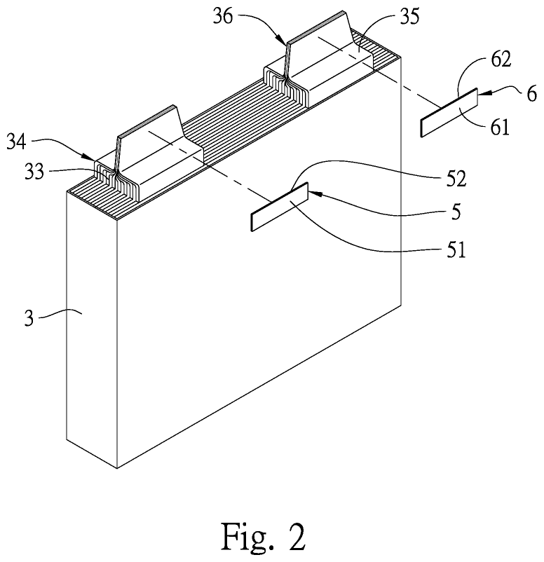

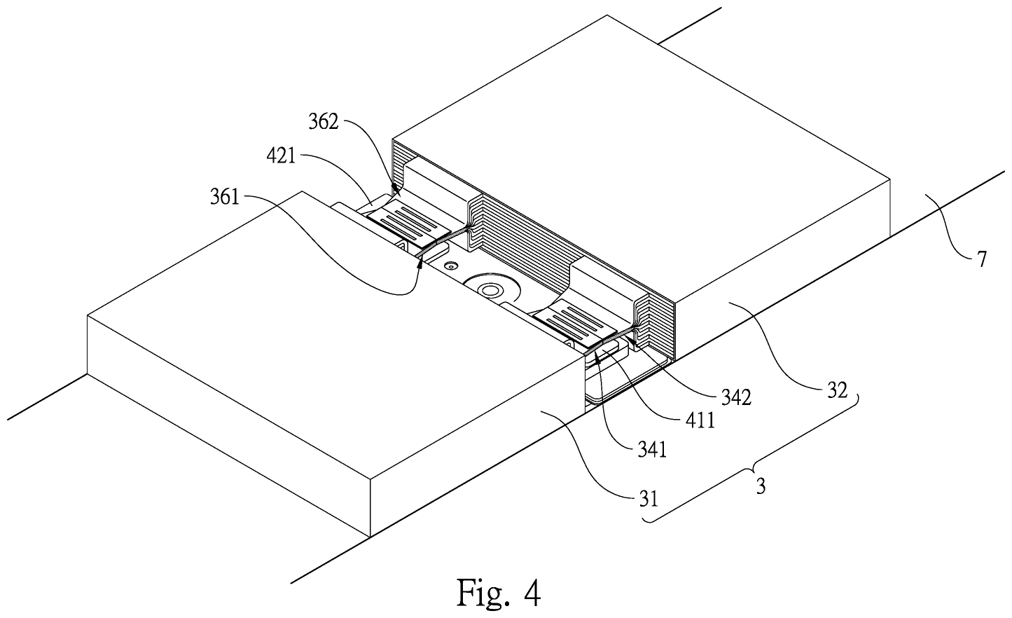

Please refer to FIGS. 1-3, which are a preferred embodiment of an electrically conductive structure 1 of lithium battery of the present invention. It mainly comprises a housing 2, a lithium battery core 3, a cover plate 4, a first metal plate 5 and a second metal plate 6. The housing 2 is hollow rectangular shaped with an opening at a top end. The lithium battery core 3 is accommodated inside the housing 2. In implementation, the lithium battery core 3 may comprise a first lithium battery core 31 and a second lithium battery core 32 in parallel as shown in FIG. 4.

The lithium battery core 3 is formed by rolling the stack of a long strip positive electrode sheet, a first isolation film, a long strip negative electrode sheet and a second isolation film into roll. A plurality of positive electrode tabs 33 is formed on one side of a top end of the lithium battery core 3. The plurality of positive electrode tabs 33 is stacked and pressurized to form a positive electrode tab set 34. A plurality of negative electrode tabs 35 is formed on the other side of the top end of the lithium battery core 3. The plurality of negative electrode tabs 35 is stacked and pressurized to form a negative electrode tab set 36. In implementation, the long strip positive electrode sheet is an aluminum sheet; the long strip negative electrode sheet is a copper sheet. The lithium battery core 3 may be formed by alternatively stacking rectangular positive electrodes sheets, first isolation films, rectangular negative electrodes sheets and second isolation films, and a positive electrode tab set 34 and a negative electrode tab set 36 are formed on two sides of the top end of the lithium battery core 3.

The cover plate 4 is a rectangular plate. The periphery of the cover plate 4 is welded to the top end of the housing 2 such that the housing 2 is covered and the lithium battery core 3 is sealed inside the housing 2. A positive electrode terminal 41 and a negative electrode terminal 42 are arranged at intervals along the long direction of the cover plate 4. A bottom end of the positive electrode terminal 41 has a rectangular first flat mesa 411. A bottom end of the negative electrode terminal 42 has a rectangular second flat mesa 421. The second flat mesa 421 and the first flat mesa 411 are flat on a bottom surface of the cover plate 4 respectively. The first flat mesa 411 is welded to one side of the positive electrode tab set 34 to form an electrically connection. The second flat mesa 421 is welded to one side of the negative electrode tab set 36 to form an electrically connection.

The first metal plate 5 is a rectangular aluminum plate with a thickness about 100 nm. The first metal plate 5 has a first top surface 51 and a first bottom surface 52 in opposite directions. The first bottom surface 52 is completely flat welded to the other side of the positive electrode tab set 34 to form an electrically connection. The second metal plate 6 is a rectangular copper plate with a thickness about 100 nm. The second metal plate 6 has a second top surface 61 and a second bottom surface 62 in opposite directions. The second bottom surface 62 is completely flat welded to the other side of the negative electrode tab set 36 to form an electrically connection.

Based on the above structure, the present invention which has been tested over a long time has a very good result. Its internal resistance is lower than 0.2 mΩ which is measured by a measurement method of AC internal resistance (ACIR). And when the lithium battery core 3 is being charged or discharged, the temperature of the housing 2 is low.

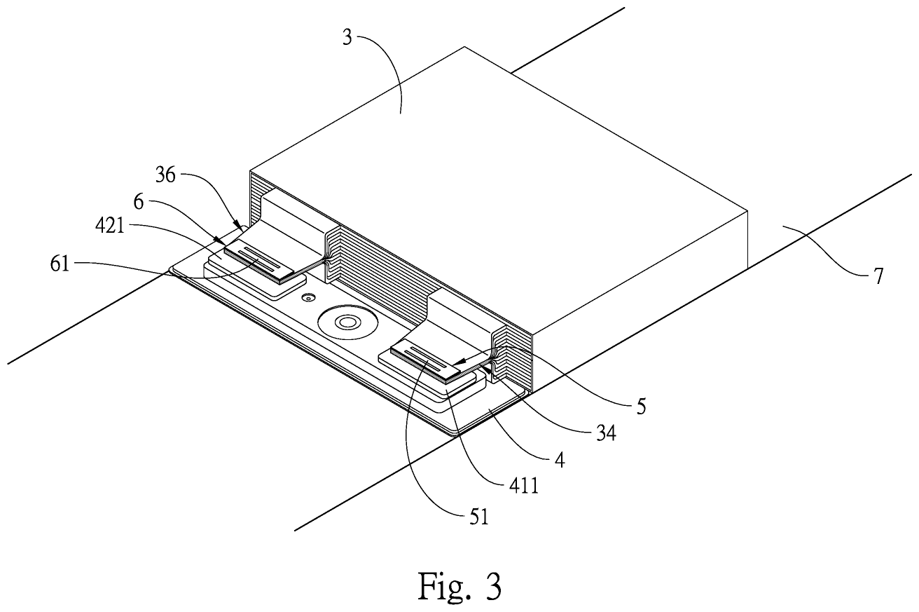

Based on the above structure, a preferred embodiment of a forming method of the electrically conductive structure 1 of lithium battery of the present invention comprises following steps of:
A: providing the lithium battery core 3.
B: welding the first metal plate 5 to the positive electrode tab set 34 such that the first bottom surface 52 of the first metal plate 5 and the positive electrode tab set 34 are jointed; then welding the second metal plate 6 to the negative electrode tab set 36 such that the second bottom surface 62 of the second metal plate 6 and the negative electrode tab set 36 are jointed.
C: as shown in FIG. 3, positioning the cover plate 4 on a workbench 7 such that the bottom surface of the cover plate 4, the first flat mesa 411 and the second flat mesa 421 are all facing upward;
D: overlapping the positive electrode tab set 34 on the first flat mesa 411 and welding them from the first top surface 51 of the first metal plate 5; and, at the same time, overlapping the negative electrode tab set 36 on the second flat mesa 421 and welding them from the second top surface 61 of the second metal plate 6.
E: bending the positive electrode tab set 34 and the negative electrode tab set 36, putting the lithium battery core 3 into the inside of the housing 2 and then welding the cover plate 4 to the top end of the housing 2.

In implementation, before the step A, the forming method further comprises a cutting step: cutting off one end of the positive electrode tab set 34 and one end of the negative electrode tab set 36 according to the actual need of different lengths to make them flat respectively.

In the step B, the first metal plate 5 and the second metal plate 6 are welded to the positive electrode tab set 34 by ultrasonic welding and the negative electrode tab set 36 by ultrasonic welding, and are welded from the first top surface 51 of the first metal plate 5 and the second top surface 61 of the second metal plate 6, respectively. In the step D, both the welding methods of welding the first flat mesa 411 to the positive electrode tab set 34 and the first metal plate 5 and welding the second flat mesa 421 to the negative electrode tab set 36 and the second metal plate 6 are laser welding; and the same here, the welding are from the first top surface 51 of the first metal plate 5 and the second top surface 61 of the second metal plate 6, respectively. In this way, during welding by ultrasonic welding or laser welding, the first metal plate 5 and the second metal plate 6 can protect the positive electrode tab set 34 and the negative electrode tab set 36, respectively, so as to prevent the positive electrode tabs 33 or the negative electrode tabs 35 from being damaged. Furthermore, since laser welding belongs to non-contact welding and the laser focus is instantaneously emitted by pulses, the welding is processed through raising the temperature to thousands of degrees Celsius to melt and evaporate the metal material in a few milliseconds. Hence, it is not needed to pressurize the first metal plate 5 and the second metal plate 6 during welding. It can be applied to the welding of the positive electrode tab set 34 to the first flat mesa 411 and the welding of the negative electrode tab set 36 to the second flat mesa 421 on one side of the top end of the lithium battery core 3, respectively.

Please refer to FIG. 4, which shows another embodiment of the forming method of the electrically conductive structure 1 of lithium battery of the present invention. The lithium battery core 3 comprises a first lithium battery core 31 and a second lithium battery core 32. The positive electrode tab set 34 comprises a first positive electrode tab set 341 and a second positive electrode tab set 342. The negative electrode tab set 36 comprises a first negative electrode tab set 361 and a second negative electrode tab set 362, that is, the first lithium battery core 31 has the first positive electrode tab set 341 and the first negative electrode tab set 361 and the second lithium battery core 32 has the second positive electrode tab set 342 and the second negative electrode tab set 362.

In the step D, firstly the first lithium battery core 31 and the second lithium battery core 32 are placed in reverse such that the first positive electrode tab set 341 and the second positive electrode tab set 342 are placed on the first flat mesa 411 in parallel; at the same time, the first negative electrode tab set 361 and the second negative electrode tab set 362 are placed on the second flat mesa 421 in parallel; and then processing welding by laser welding; and after welded, bending the first lithium battery core 31 and the second lithium battery core 32 respectively to combine both in one lithium battery core 3; and then the putting the lithium battery core 3 into the inside of the housing 2.

To sum up, according to the description disclosed above, the present invention does not need to use the conventional connecting piece, but directly welds the positive electrode tab set of the lithium battery core to the first flat mesa of the cover plate and welds the negative electrode tab set to the second flat mesa. Since the positive and the negative electrode tab sets are directly welded to the first and the second flat mesas, respectively, with large areas, such that not only the conductive voltage and current can be stabilized, but also the needs of high-rate and high-current charging and discharging can be met and the internal resistance can be reduced to improve electrical conductivity. Since the overall surface area of the conductive part is greatly reduced, the self-discharge rate can effectively be reduced to extend the life time of the lithium battery core. Therefore, the present invention can indeed achieve the expected purpose by providing an electrically conductive structure of lithium battery and forming method thereof that not only can effectively reduce the internal resistance to make the conduction smooth, but also can stabilize the conduction voltage to ensure the function and consistency of the lithium battery core and can extend the life time of the lithium battery. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An electrically conductive structure of lithium battery, comprising:
a housing having a lithium battery core inside, a top end of said lithium battery core has a positive electrode tab set and a negative electrode tab set;
a cover plate, a top end of said housing is covered by and welded to said cover plate, said cover plate has a positive electrode terminal and a negative electrode terminal, a bottom end of said positive electrode terminal has a first flat mesa, said first flat mesa is welded to said positive electrode tab set, a bottom end of said negative electrode terminal has a second flat mesa, said second flat mesa is welded to said negative electrode tab set;
a first metal plate having a first top surface and a first bottom surface in opposite directions, said first bottom surface is completely flat welded to said positive electrode tab set; and
a second metal plate having a second top surface and a second bottom surface in opposite directions, said second bottom surface is completely flat welded to said negative electrode tab set.

2. The electrically conductive structure of lithium battery according to claim 1, wherein said lithium battery core comprises a first lithium battery core and a second lithium battery core in parallel.

3. The electrically conductive structure of lithium battery according to claim 1, wherein said first metal plate is an aluminum plate.

4. The electrically conductive structure of lithium battery according to claim 1, wherein said second metal plate is a copper plate.

5. A forming method of the electrically conductive structure of lithium battery according to claim 1 comprising following steps of:
A: providing said lithium battery core;
B: welding said first metal plate to said positive electrode tab set such that said first bottom surface of said first metal plate and said positive electrode tab set are jointed; welding said second metal plate to said negative electrode tab set such that said second bottom surface of said second metal plate and said negative electrode tab set are jointed;
C: positioning said cover plate on a workbench such that said first flat mesa and said second flat mesa are both facing upward;
D: overlapping said positive electrode tab set on said first flat mesa and welding them from said first top surface of said first metal plate; overlapping said negative electrode tab set on said second flat mesa and welding them from said second top surface of said second metal plate; and
E: putting said lithium battery core into said housing and then welding said cover plate to said top end of said housing.

6. The forming method of the electrically conductive structure of lithium battery according to claim 5, wherein, before said step A, said forming method further comprises a cutting step: cutting one end of said positive electrode tab set and one end of said negative electrode tab set.

7. The forming method of the electrically conductive structure of lithium battery according to claim 5, wherein in said step B, said first metal plate and said second metal plate are welded to said positive electrode tab set and said negative electrode tab set by ultrasonic welding respectively.

8. The forming method of the electrically conductive structure of lithium battery according to claim 5, wherein in said step D, said weldings are done by laser welding respectively.

9. The forming method of the electrically conductive structure of lithium battery according to claim 5, wherein said lithium battery core comprises a first lithium battery core and a second lithium battery core, said positive electrode tab set comprises a first positive electrode tab set and a second positive electrode tab set, said negative electrode tab set comprises a first negative electrode tab set and a second negative electrode tab set; said first lithium battery core has said first positive electrode tab set and said first negative electrode tab set, said second lithium battery core has said second positive electrode tab set and said second negative electrode tab set; in said step D, said first lithium battery core and said second lithium battery core are placed in reverse such that said first positive electrode tab set and said second positive electrode tab set are in parallel placed on and welded to said first flat mesa, said first negative electrode tab set and said second negative electrode tab set are in parallel placed on and welded to said second flat mesa; and after welded, said first lithium battery core and said second lithium battery core are bended respectively to be combined.
